(19) United States
(12) Patent Application Publication
(10) Pub. No.: US 2007/0289991 A1
(43) Pub. Date: Dec. 20, 2007

(54) Colorant Dispenser Having an Outlet Control Valve

(76) Inventor: Larry Jensen, Mundelein, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/425,247

(22) Filed: Jun. 20, 2006

(51) Int. Cl. G01F 11/00; B67D 5/40; B65D 35/38

(52) U.S. Cl. 222/1; 222/380; 222/494; 222/144; 222/144.5

(57) ABSTRACT

A colorant dispenser for dispensing colorant is disclosed having a primary valve and a secondary, outlet control valve. The primary valve is shiftable from a closed position, whereby colorant is prevented from being dispensed from a reservoir, to an open position whereby colorant is permitted to be dispensed from the reservoir. The secondary valve is positioned downstream of the primary valve, and is adapted to permit colorant flow when the primary valve is in its open position in response to pressure from the colorant flow and to restrict colorant flow and drying of colorant downstream of the primary valve and upstream of the secondary valve when the primary valve is in its closed position.

### FIELD

This disclosure relates to a colorant dispenser for use in either automatically or manually dispensing a colorant, and in particular to a colorant dispenser having an outlet control valve.

### BACKGROUND

Colorant dispensers are used to dispense colorant in predeterminable amounts in order to color a base paint. The colorants are highly concentrated materials capable of being mixed with the base paint to change the color of the base paint. One or more colorant dispensers, each containing a different colorant, may sequentially dispense their respective colorants into the base paint and the different colorants are combined with the base paint to provide a paint mixture have a particular color. The colorant dispensers may be manually operated, fully automatic, or a combination thereof. By varying the types and amounts of the colorants that are combined with the base paint, a large variety of different colors of paint mixture can be achieved using a comparative small number of different colorants and colorant dispensers. For example, a particular color of paint can be made by combining predeterminable amounts of different colorants according to a formulation.

One problem with colorant dispensers is drippage. Drippage can occur, for instance, when the flow of colorant from the colorant dispenser has been stopped, but residual amounts of colorant remain in the flow path and can drip from the colorant dispenser. Due to the highly concentrated nature of the colorant, even very small amounts can change the color of the base paint. For instance, quantities of colorant as small as 1/256^{th} of a U.S. ounce have been found to change the color of a base paint. Thus, efforts have been made to reduce inadvertent drippage of colorant from colorant dispensers.

Efforts to reduce inadvertent drippage of colorant from colorant dispensers include the use of manually actuable secondary valves. For example, U.S. Pat. No. 5,356,041 discloses a colorant dispenser having an upstream valve member and a sealing valve. The sealing valve is shiftable from its closed position to its open position when an actuator arm attached to the sealing valve is manipulated by sliding relative to a cam. In another example, reduction of drippage is sought to be achieved using a “sniff-back” mechanism. The “sniff-back” mechanism comprises a retractable rod, located adjacent to the outlet flow path, that is slid into a retracted position as the dispensing valve of the colorant dispenser is moved to its closed position in order to increase the volume of the outlet flow path with the objective of reducing drippage when the dispensing valve is in its closed position.

Another problem with colorant dispensers is drying of colorant that may remain in the flow path downstream of a sealing valve. Dry colorant in the flow path can restrict flow of colorant therepast with the sealing valve is opened to permit colorant flow therepast, which can reduce the control of the quantity of colorant that is dispensed and adversely impact the particular color of a paint that is to be tinted using the colorant.

Despite past efforts to reduce inadvertent drippage of colorant from colorant dispensers and drying of colorant, there remains a continued need for reducing such inadvertent drippage and drying of colorant.

### SUMMARY

A colorant dispenser for dispensing colorant is disclosed having a primary valve and a secondary valve. The primary valve is shiftable from a closed position, whereby colorant is prevented from being dispensed from a reservoir, to an open position whereby colorant is permitted to be dispensed from the reservoir. The secondary valve is positioned downstream of the primary valve, and is adapted to permit colorant flow when the primary valve is in its open position and to both restrict colorant flow when the primary valve is in its closed position and to reduce drying of colorant disposed downstream of the primary valve in its closed position.

The secondary valve may be adapted to permit colorant flow when the primary valve is in its open position and in response to a flow of colorant from the reservoir. To dispense colorant from the reservoir, the primary valve is shifted from its closed position to its open position to permit the colorant to flow from the reservoir to the secondary valve. In response to the primary valve being in its open position and the flow of colorant from the reservoir, the secondary valve shifts to an open position to permit the colorant to flow from the colorant dispenser. When the primary valve is shift shifted from its open position to its closed position and the flow of colorant from the reservoir is stopped, the secondary valve shifts to a closed position to restrict both the flow and drying of any remaining colorant remaining downstream of the primary valve. Preferably, though not necessarily, the secondary valve is the last component of the colorant dispenser that colorant contacts.

The secondary valve may be self-actuating in response to colorant flow from the reservoir when the primary valve is shifted from the closed position to the open position. To this end, the secondary valve may have a peripheral rim, a center region, and a flexible membrane extending between the rim and the center region. The secondary valve may be formed from a flexible, elastic material. The center region has one or more openings formed therein, which may be in the form of one or more slits. If there is a plurality of slits, then the slits may be intersecting. The one or more openings of the center region may flex open in response to colorant flow from the reservoir and, due to the elastic nature of the valve, flex closed when the colorant flow from the reservoir is terminated. In one aspect, the center region of the secondary or outlet control valve may be positioned on one side of the peripheral rim when there is no colorant flow from the reservoir and may be positioned on an opposite side of the peripheral rim when there is colorant flow from the reservoir.

The amount of force required to open and close the secondary valve can be selected according to the desired flow rates and amounts of the colorant. For instance, the repositioning of the center region on one side or the other of the peripheral rim may depend upon the elastic properties of the material forming the secondary valve and the properties of the colorant, such as viscosity and flow rate.

The colorant dispenser may be manually or automatically operated. For example, a manually operated colorant dispenser may have a primary valve that is manually shifted between its open and closed positions. An automatic colorant dispenser may have a primary valve that is electronically shifted between its open and closed positions. Various types of primary valves are suitable for use with the colorant dispenser. For instance, a rotary valve can be suitable for use with a manually operated colorant dispenser. A motorized valve, such as a step valve or volumetric valve, can be suitable for use with an automatic colorant dispenser. Moreover, multiple outlet control valves may be used in a distribution head having fluid connections to a plurality of different colorant dispensers.

### BRIEF DESCRIPTION OF THE DRAWINGS

FIG. 1 is a front perspective view of multiple colorant dispensers mounted on a dispensing platform and showing receptacles;

FIG. 2 is a front perspective view of a colorant dispenser removed from the dispensing platform of FIG. 1;

FIG. 3 is a top plan view of the colorant dispenser of FIG. 2;

FIG. 4 is perspective view of a distribution head having multiple outlet control valves for use with multiple colorant dispensers;

FIG. 5 is a top plan view of a valve block of the colorant dispenser of FIG. 2;

FIG. 6 is a front elevation view of the valve block of the colorant dispenser of FIG. 2;

FIG. 7 is a front elevation, cross-section view of an outlet control valve and a mounting cap;

FIG. 8 is a top plan view of the drip control valve of FIG. 7; and

FIG. 9 is a side elevation, cross-section view of the outlet control valve taken along line IX-IX of FIG. 8.

### DETAILED DESCRIPTION OF THE DRAWINGS

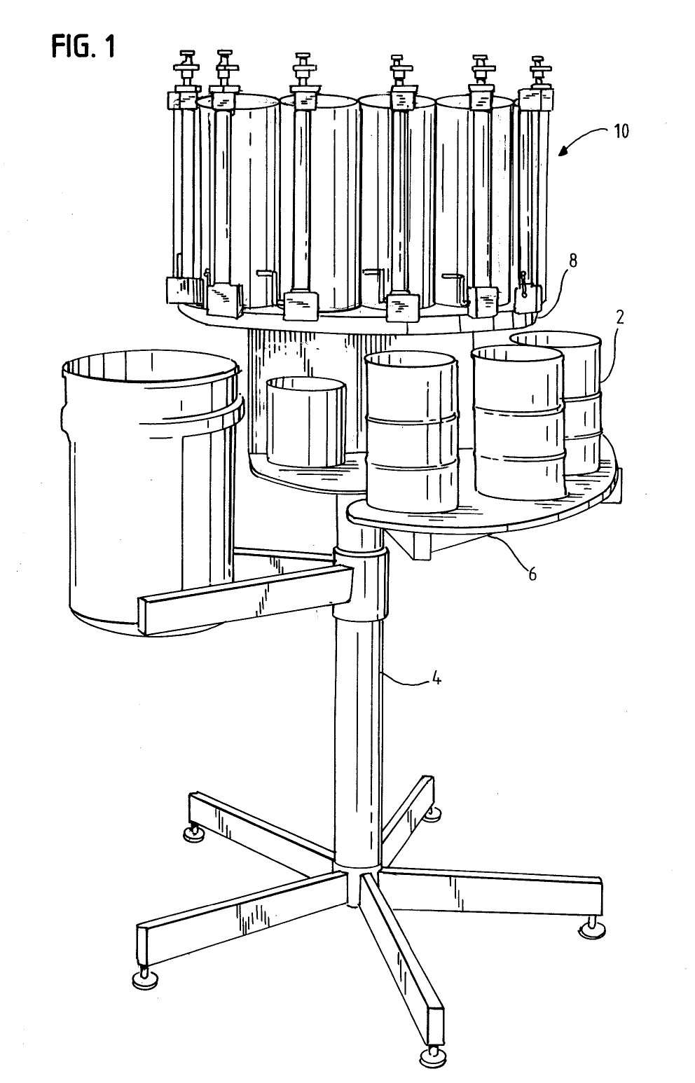

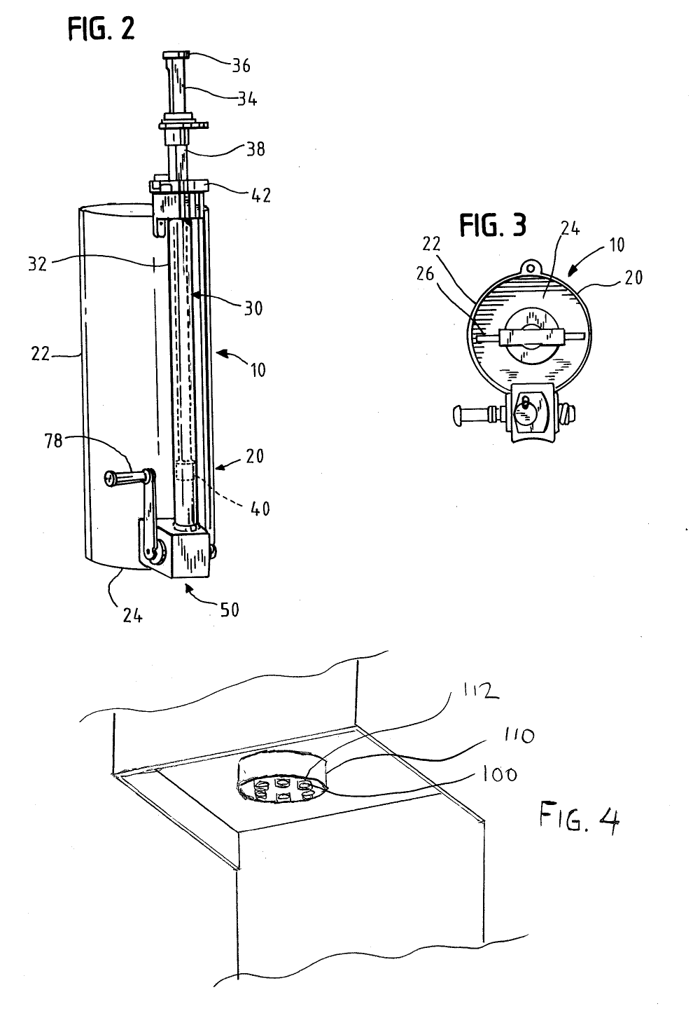

A colorant dispenser having both a primary valve for selectively controlling colorant flow from a reservoir and a secondary valve that shifts from a closed position to an open position in response to colorant flow from the reservoir and returns to the closed position when colorant flow from the reservoir ceases is disclosed herein and illustrated in FIGS. 1-9. The use of a secondary valve that is responsive to selective colorant flow from a reservoir is suitable for use with colorant dispensers that are automatically or manually operated, as well as for use with distribution heads for multiple colorant dispensers.

The manually operated colorant dispenser 10 includes a storage reservoir 20 for colorant. A fluid passage 80 connects the storage reservoir 20 to a metering reservoir 30. A plunger rod 38 having a plunger 40 on an end thereof is slidable within the metering reservoir 30, the operation of which will be described in greater detail. The plunger 40 forms a seal with the interior of the metering reservoir 30. A valve block 50 having a primary valve 74 and a secondary valve 100 is disposed downstream of the metering reservoir 30. An outlet passage 56 extends between the primary valve 74 and the secondary valve 100. Each of the primary and secondary valves 74 and 100 are shiftable between open positions which permit colorant flow therepast and closed positions which restrict and ideally prevent colorant flow therepast.

To transfer colorant from the storage reservoir 20 to the metering reservoir 30, the plunger rod 38 and plunger 40 are shifted from an extended position to a retracted position. In the retracted position the volume of the metering reservoir 30 bounded in part by the plunger 40 is increased in order to draw a predeterminable quantity of colorant from the storage reservoir 20 into the metering reservoir 30 via the fluid passage 80. The primary valve 74 in its closed position permits fluid flow from the storage reservoir 20 into the metering reservoir 30, the details of which will be discussed below.

To dispense the predeterminable quantity of colorant from the metering reservoir 30, the primary valve 74 is first shifted from its closed position to its open position where colorant flow is permitted from the metering reservoir 30 but not between the storage reservoir 20 and the metering reservoir 30. Next, the plunger rod 38 is shifted to its extended position whereby the plunger 40 is moved within the metering reservoir 30 toward the primary valve 74 to decrease the volume within the metering reservoir between the plunger 40 and the primary valve 74, thereby forcing the quantity of colorant from the metering reservoir 30 and past the primary valve 74 into the outlet passage 56 extending between the primary valve 74 and the secondary valve 100. The flow of the quantity of colorant in the outlet passage 56 forces the secondary valve 100 to shift from its closed position to its open position to permit flow of the quantity of colorant from the colorant dispenser 10, for example, and into a container 2 positioned beneath the secondary valve 100. When the predeterminable quantity of colorant has exited the colorant dispenser 10 and the flow of colorant from the metering reservoir 30 has ceased, the secondary valve 100 returns to its closed position to both restrict drippage and reduce drying of any colorant in the outlet passage 56.

The secondary valve 100 in its closed position restricts, and preferably though not necessarily eliminates, drippage of any colorant remaining in the outlet passage 56 after the primary valve 74 has been returned to its closed position. The secondary valve 100 in its closed position also reduces drying of any colorant remaining in the outlet passage 56 after the primary valve 74 has been returned to its closed position. This can advantageously reduce unintentional changes to the color of a base paint that the predeterminable quantity of colorant is mixed with due to inadvertent drippage of colorant following dispensing of the quantity of colorant from the metering reservoir 30 or due to drying and, in some circumstances, clogging that can restrict intentional flow.

The secondary valve 100 preferably, though not necessarily, is formed of a flexible, elastomeric material, such as silicon. The secondary valve 100 has a peripheral rim 102, a center portion 104 and a flexible membrane 106 extending between the peripheral rim 102 and the center portion 104, as illustrated in FIGS. 8 and 9. The center portion 104 includes a pair of intersecting slits 108. When there is no flow of colorant from the metering reservoir 30, the center portion 104 of the secondary valve is positioned on an upstream side of the peripheral rim 102. However, when colorant flow from the metering reservoir contacts the center portion 104 of the secondary valve 100, a sufficient amount of colorant pressure causes the center portion 104 of the secondary valve 100 to move, against a biasing force provided by the flexible membrane 106, into a position disposed on an opposite, downstream side of the peripheral rim 102. Continued force of colorant on the center portion 104 causes the slits 108 to open and colorant to be dispensed therethrough. When the flow of the predeterminable quantity of colorant from the metering reservoir 30 is ceased and the primary valve 74 is shifted from its open position to its closed position, the lack of pressure against the center portion 104 from the colorant flow results in both closure of the slits 108 and the flexible membrane 106 urging the center portion 104 back to the upstream position relative to the peripheral rim 102. The biasing force exerted by the flexible membrane 106 and the center portion 104 to close the slits 108 is preferable selected such that drippage of any remaining colorant in the outlet passage 56 is restricted or even prevented when the primary valve 74 is in its closed position, as well as restricting the passage of air into the outlet passage 56 to reduce drying of any colorant remaining therein.

One suitable type of secondary valve 100 is the V8 Valve available from Liquid Molding Systems, Midland, Mich. The operation of suitable secondary valves are also disclosed in U.S. Pat. Nos. 5,213,236 and 5,409,144, the disclosures of which are hereby incorporated by reference in their entireties.

Turning now to more of the details of one particular embodiment, the colorant dispenser 10 is suitable for use with a dispensing system 4 having a plurality of different lower platforms 6 for supporting differently-sized containers 2 of base paint, such as one quart, one gallon and five gallon containers, as illustrated in FIG. 1. An upper platform 8 is positioned to support multiple colorant dispensers 10 such that they can selectively dispense colorant into the containers 2 below. The upper platform 8 can be rotatable such that different colorant dispensers 10 containing different colorants can be selectively positioned above a container 2.

The storage reservoir 20 of the colorant dispenser 10 has a generally cylindrical sidewall 22, an open top and a bottom closed with a wall 24, as illustrated in FIGS. 3 and 4. A stirring paddle 26 is positioned within the storage reservoir 20 to stir colorant contained therewithin, and can be externally driven via an extension of the paddle 26 that protrudes through the bottom wall 24 of the storage reservoir 20. The metering reservoir 30 of the colorant dispenser also has a generally cylindrical sidewall 32 and an open top. The bottom of the metering reservoir 30, however, is receiving with a seat 52 formed within the valve block 50.

The valve block 50 includes multiple fluid passages, including a connecting passage 80 extending between the storage reservoir 20 and the metering reservoir 30 and the outlet passage 56 extending between the primary valve 74 and the secondary valve 100. The primary valve 74 selectively permits fluid flow through both of the connecting passage 80 and the outlet passage 56. More specifically, when the primary valve 74 is in its closed position fluid is permitted to flow through the connecting passage 80 from the storage reservoir 20 into the metering reservoir 30. However, when the primary valve 74 is in its closed position fluid flow from the metering reservoir 30 to the outlet passage 56 is prevented. Conversely, when the primary valve 74 is in its open position fluid is prevented from flowing through the connecting passage 80 between the storage reservoir 20 and the metering reservoir 30 but is permitted to flow through the outlet passage 56 to the secondary valve 100.

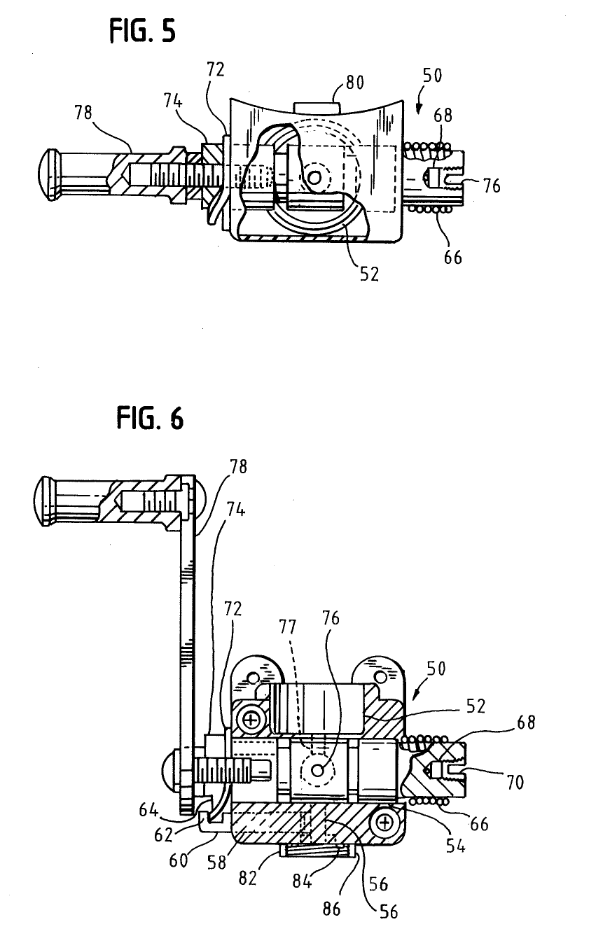

The primary valve 74 comprises a shaft 72 that is rotatably received within the valve block 50 with its ends protruding from the valve block 50, as illustrated in FIGS. 5 and 6. The shaft 72 has a pair of intersecting passages 76 and 77 formed therein. One of the passages, the through passage 76, extends through the entire diameter of the shaft 72 and the other of the passages, the intersecting passage 77, extends normal to the axis of the through passage 76 and to its intersection the through passage 76. When the primary valve 74 is in the open position, the through passage 76 is aligned to permit colorant flow from the metering reservoir 30 to the outlet passage 56 and the intersecting passage 76 is blocked to prevent colorant flow between the metering reservoir 30 and the storage reservoir 20. When the primary valve 74 is in the closed position, the through passage 76 is blocked to prevent colorant flow from the metering reservoir 30 to the outlet passage 56 and the intersecting passage 77 and a portion of the through passage 76 are orientated to permit colorant to be transferred from the storage reservoir 20 to the metering reservoir 30.

One end of the shaft 72 has a coil spring 66 having one end attached to the valve block 50 and the other end received within a slit 68 formed in the one end of the shaft 72 and held in place using a set screw 70. The spring 66 biases the shaft 72 into the closed position, whereby flow is permitted through the passages 80, 76 and 77 from the storage reservoir 20 into the metering reservoir 20 while flow from the metering reservoir 30 to the outlet passage 56 is blocked. The opposite end of the shaft 72 has an attached handle 78 that is used to rotate the shaft 72 from the closed position to the open position against the biasing force of the spring 66 such that the through passage 76 is aligned to permit colorant flow from the metering reservoir 30 to the outlet passage 56 and the flow of colorant between the storage reservoir 20 and the metering reservoir 30 is blocked.

A “sniff-back” mechanism is optionally included to assist in reducing drippage. This mechanism includes a sniff-back passage 58 that intersects the outlet passage 56 in the valve block 50. A sniff-back rod 60 is reciprocally slidable within the sniff-back passage 58 between an extended position, where the rod 60 is closest to but not entering the outlet passage 56, and a retracted position, where the rod is further spaced from the outlet passage 56. The sliding of the sniff-back rod 60 within the sniff-back passage 58 is actuated by rotation of the shaft 72 of the primary valve 74. A cam actuator 64 is fixed to the shaft 72 and has an end that rests in a groove 62 formed in a protruding end of the sniff-back rod 60. When the primary valve 74 is in its closed position, the sniff-back rod 60 is in its retracted position. However, shifting of the primary valve 74 from its closed position to its open position also causes the sniff-back rod 60 to shift toward its extended position, thereby decreasing the volume of the outlet passage 56 and the portion of the sniff-back passage 58 between the outlet passage 56 and the adjacent end of the rod 60. After the predeterminable quantity of colorant has been dispensed from the metering reservoir 30, the primary valve 74 is returned to its closed position, which causes the cam actuator 64 to slide the sniff-back rod 60 to its retracted position to thereby increase the volume of the outlet passage 56 and the portion of the sniff-back passage 58 between the outlet passage 56 and the adjacent end of the rod 60. The use of the sniff-back mechanism functions to reduce drippage by increasing the volume of the outlet passage 56 and the portion of the sniff-back passage 58 between the outlet passage 56 and the adjacent end of the rod 60 when the primary valve 74 is in its closed position.

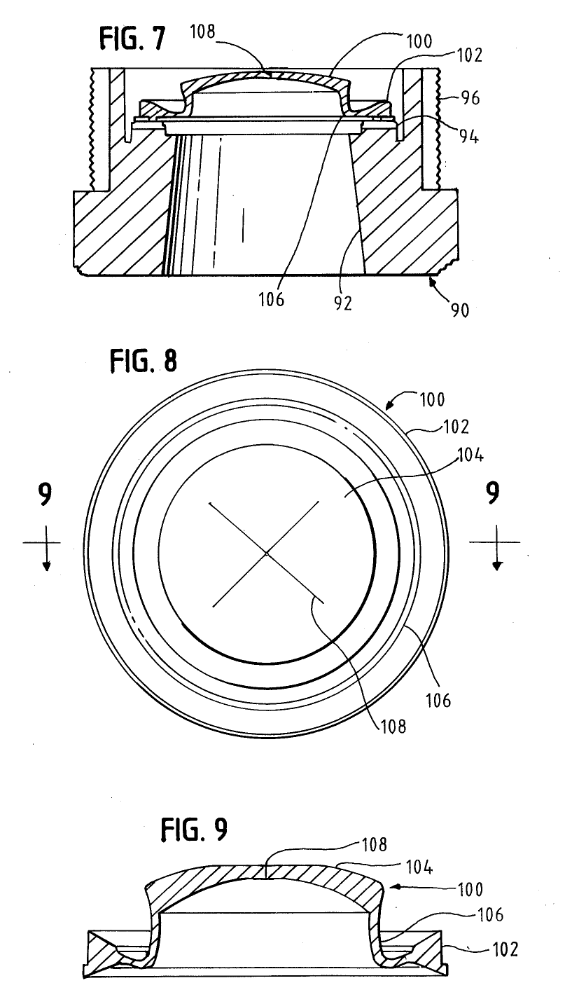

An end of the valve block 50 has a secondary valve connection 82 adapted to threadingly mate with a secondary valve seat 90, as illustrated in FIGS. 6 and 7. The secondary valve connection 82 has an internal thread 86 that is adapted to engage with an external thread 96 of the secondary valve seat 90 to secure the secondary valve 100 relative to the valve block 50. To this end, the peripheral rim 102 of the secondary valve 100 is clamped in place between an internal shoulder 94 of the secondary valve seat 90 and an internal shoulder 84 of the secondary valve connection 82. The secondary valve seat 90 also includes an outlet 92 that is sized such that, preferably, the colorant dispensed through the secondary valve 100 does not contact the sidewalls bounding the outlet 92. It is preferred, though not necessary, that the secondary valve 100 is the last component of the colorant dispenser 10 that is in contact with the colorant being dispensed in order to reduce drippage and drying.

Turning now to more of the details of the operation of the metering reservoir 30, plunger rod 38 and plunger 40, a metering rod 34 having a metering stop 36 is slidably received within the plunger rod 38 and is used to predetermine the quantity of colorant for transfer from the storage reservoir 20 to the metering reservoir 30. More specifically, the metering rod 34 can be slid upwardly relative to the metering reservoir 30 and held in place using a spring-loaded ratchet 42. The metering rod 34 has measurement markings thereon to indicate the amount of volume of colorant desired to be transferred from the storage reservoir 20 to the metering reservoir 30. To draw a predetermined quantity of colorant from the storage reservoir 20 and into the metering reservoir 30, as described above, the plunger rod 38 and attached plunger 40 is shifted to the retracted position with the primary valve 74 in the closed position. When an upper end of the plunger rod 38 contacts the metering stop 36, further retraction of the plunger 40 is halted as the predetermined quantity of colorant has been drawn into the metering reservoir 30. The plunger rod 38 and plunger 40 can then be depressed to dispense the colorant from the metering reservoir 30 when the primary valve 74 is in its open position. The metering rod 34 can then be readjusted if necessary by depressing the spring-loaded ratchet 42.

An automatic colorant dispenser may have only a single reservoir with the colorant flow and quantity of colorant to be dispensed determined using an electronic controller which selectively activates a valve. Different types of suitable valves include valves controlled by step motors, where the quantity of colorant dispensed is determined by the number of rotations of the step motor, and a volumetric valve. The electronic controller may actuate the valve to permit a predetermined amount of colorant to be dispensed according to a color formulation. It is preferable, though not necessary, that the secondary valve 100 be positioned such that it is the last component of the dispenser in the flow path of the colorant that is contacted prior to the colorant being received in a container or other receptacle in order to reduce drippage and drying.

A plurality of colorant dispensers may be provided that are each separately connected to a common distribution head 110. The distribution head 110 may include an outlet passage for each of the colorant dispensers, as illustrated in FIG. 4. The outlet passages may each have a secondary valve 100, held in place by a bracket 112, in order to reduce drippage and drying, as discussed in greater detail above.

The drawings and the foregoing descriptions are not intended to represent the only forms of the colorant dispenser having primary and secondary valves in regard to the details of construction and manner of operation. Changes in form and in the proportion of parts, as well as the substitution of equivalents, are contemplated as circumstances may suggest or render expedient; and although specific terms have been employed, they are intended in a generic and descriptive sense only and not for the purposes of limitation.

1. A colorant dispenser for selectively dispensing predeterminable amounts of colorant, the colorant dispenser comprising:
a storage reservoir for storing colorant;
a metering reservoir for receiving predeterminable amounts of colorant from the storage reservoir;
a colorant flow path positioned between the storage reservoir and the metering reservoir permitting colorant to flow from the storage reservoir to the metering reservoir;
an outlet for dispensing colorant from the metering reservoir;
a dispensing valve positioned between the metering reservoir and the outlet, the dispensing valve being selectively shiftable from a closed position to an open position to dispense colorant from the metering reservoir through the outlet; and
an outlet control valve positioned at an end of the outlet opposite the dispensing valve, the outlet control valve having an open position permitting colorant to flow therethrough when the dispensing valve is in the open position and a closed position restricting colorant flow therethrough when the dispensing valve is in the closed position, the outlet control valve being shiftable between from its closed position to its open position in response to colorant flow in the outlet when the dispensing valve is in its open position.

2. The colorant dispenser of claim 1, wherein the outlet control valve comprises a flexible element having a flexible membrane with at least one slit.

3. The colorant dispenser of claim 1, wherein the outlet control valve comprises a flexible element having a flexible membrane, a peripheral rim, and at least one slit, the at least one slit having an open position permitting colorant from the metering reservoir to be dispensed therethrough when the dispensing valve is in its open position and a closed position when the dispensing valve is in its closed position.

4. The colorant dispenser of claim 3, wherein the at least one slit is positioned on one side of the peripheral rim in its open position and on another side of the peripheral rim in its closed position.

5. The colorant dispenser of claim 4, wherein the at least one slit comprises a pair of intersecting slits.

6. The colorant dispenser of claim 3, further comprising:
a valve housing, the valve housing having the colorant flow path and the outlet formed therein and configured to receive the dispensing valve; and
a mounting bracket for the flexible element, the mounting bracket attachable to the valve housing to align the flexible element with the outlet.

7. The colorant dispenser of claim 6, wherein:
the dispensing valve comprises a valve shaft having a passage extending therethrough, the shaft being rotatable in an aperture formed in the valve housing between the open position of the dispensing valve where the aperture of the shaft is aligned with the outlet to permit colorant to flow from the metering reservoir through the outlet and the closed position of the dispensing valve where the aperture of the shaft is not aligned with the outlet to prevent colorant from flowing from the metering reservoir through the outlet, the shaft being biased to the closed position of the dispensing valve; and
a portion of the outlet being intersected by a return aperture, the return aperture containing a draw back shaft that reciprocates between an extended and a retracted position, an end of the draw back shaft adjacent the outlet being spaced from the portion of the outlet in the extended position and in the retracted position being further spaced from the outlet than in the extended position, the draw back shaft reciprocating from the extended position to the retracted position when the valve shaft is rotated from the open position to the closed position of the dispensing valve and reciprocating from the retracted position to the extended position when the valve shaft is rotated from the closed position to the open position of the dispensing valve.

8. The colorant dispenser of claim 1, wherein a plunger has at least a portion that is slidable within the metering reservoir between a retracted position and an extended position, sliding of the plunger toward the retracted position drawing fluid from the storage reservoir, through the colorant flow path between the storage reservoir and the metering reservoir, and into the metering reservoir, and sliding of the plunger toward the extended position when the dispensing valve is in its open position discharging fluid from the metering reservoir and through the outlet and outlet control valve.

9. The colorant dispenser of claim 8, wherein the dispensing valve is positioned in the colorant flow path between the storage reservoir and the metering reservoir, the dispensing valve in the open position permitting colorant flow from the storage reservoir to the metering reservoir when the plunger is slid toward the retract position and in the closed position preventing colorant flow from the storage reservoir to the metering reservoir.

10. A method of dispensing colorant from a colorant dispenser, the method comprising:
transferring a predeterminable amount of colorant from a storage reservoir to a metering reservoir via a fluid passage between the storage reservoir and the metering reservoir; and
dispensing at least some of the predeterminable amount of colorant from the metering reservoir through a dispensing passage having an inlet opening adjacent the metering reservoir and an outlet opening and through an outlet control valve adjacent the outlet opening of the dispensing passage when a selectively openable dispensing valve positioned between the dispensing passage and the metering reservoir is shifted from a closed position to an open position, the outlet control valve shifting from a closed position restricting colorant flow to an open position permitting colorant flow therethrough in response to colorant flow in the dispensing passage when the dispensing valve is in the open position.

11. The method of dispensing colorant of claim 1, wherein the outlet control valve comprises a flexible element having a flexible membrane with at least one slit.

12. The method of dispensing colorant of claim 1, wherein the outlet control valve comprises a flexible element having a flexible membrane, a peripheral rim, and at least one slit, the at least one slit having an open position permitting colorant from the metering reservoir to be dispensed therethrough when the dispensing valve is in its open position and a closed position when the dispensing valve is in its closed position.

13. The method of dispensing colorant of claim 12, wherein the at least one slit is positioned on one side of the peripheral rim in its open position and on another side of the peripheral rim in its closed position.

14. The method of dispensing colorant of claim 13, wherein the at least one slit comprises a pair of intersecting slits.

15. The method of dispensing colorant of claim 10, wherein:
the step of transferring a predeterminable amount of colorant from a storage reservoir to a metering reservoir via a fluid passage between the storage reservoir and the metering reservoir includes the step of sliding a plunger disposed at least partially within the metering reservoir from a retracted position to an extended position whereby an interior volume of the metering reservoir bounded by an end of the plunger is increased; and
the step of dispensing at least some of the predeterminable amount of colorant from the metering reservoir includes the step of sliding the plunger from an extended position to a retracted position whereby the interior volume of the metering reservoir bounded by the end of the plunger is decreased.

16. A colorant dispenser for selectively dispensing predeterminable amounts of colorant, the colorant dispenser comprising:
a reservoir for colorant;
an outlet for dispensing colorant from the reservoir;
dispensing means for selectively dispensing colorant from the reservoir through the outlet; and
outlet control means for controlling dripping from the outlet and drying.

17. The colorant dispenser of claim 16, wherein the outlet is formed in a distribution head having multiple outlets each separately connected to different reservoirs and having outlet control means.
